(19) United States
(12) Patent Application Publication
(10) Pub. No.: US 2020/0368890 A1
(43) Pub. Date: Nov. 26, 2020

(54) METHOD FOR SETTING THE STRIKING STROKE OF A STRIKING PISTON OF A PERCUSSION APPARATUS, AND A PERCUSSION APPARATUS FOR IMPLEMENTING SAID METHOD

(71) Applicant: MONTABERT, SAINT-PRIEST (FR)

(72) Inventor: Jean-Sylvain COMARMOND, VOURLES (FR)

(21) Appl. No.: 16/969,819

(22) PCT Filed: Feb. 12, 2019
(86) PCT No.: PCT/FR2019/050300

§ 371 Date: Aug. 13, 2020

(30) Foreign Application Priority Data
Feb. 14, 2018 (FR) 18/51248

(51) Int. Cl. B25D 9/26; B25D 9/18; B25D 9/20; B25D 9/14

(52) U.S. Cl. CPC B25D 9/26; B25D 9/18; B25D 2250/125; B25D 9/145; B25D 2250/005; B25D 9/20

(57) ABSTRACT

The percussion apparatus includes a striking piston and a piloting device configured to make a striking stroke of the striking piston vary, the piloting device comprising a piloting cylinder, a piloting slide mounted movable in translation within the piloting cylinder according to a direction of displacement and mounted movable in rotation within the piloting cylinder, and a main piloting chamber delimited by the piloting slide and the piloting cylinder. The percussion apparatus further includes a setting device configured to set a range of variation of the striking stroke of the striking piston, the setting device including a setting member configured to set the angular position of the piloting slide in the piloting cylinder, and at least one fluidic communication passage formed on the piloting slide and configured to hydraulically limit the translational displacement stroke of the piloting slide according to the direction of displacement according to the angular position occupied by the piloting slide.

### CROSS REFERENCE TO RELATED APPLICATIONS

This application is a National Stage of PCT Application No. PCT/FR2019/050300 filed on Feb. 12, 2019, which claims priority to French Patent Application No. 18/51248 filed on Feb. 14, 2018, the contents each of which are incorporated herein by reference thereto.

### TECHNICAL FIELD

The present invention relates to a method for setting the striking stroke of a striking piston of a percussion apparatus propelled by a pressurized incompressible fluid and a percussion apparatus for the implementation of this method.

### BACKGROUND

Percussion apparatuses propelled by a pressurized incompressible fluid such as rock breakers, are supplied with fluid, such that the resultant of the hydraulic forces applied successively on the striking piston, displaces the latter in a reciprocating manner in one direction and then in the other.

In this type of apparatuses, the striking piston is displaced in a reciprocating manner inside a piston cylinder in which are formed at least two opposite control chambers with different sections. One of the two control chambers, constantly supplied with pressurized fluid and also called bottom chamber, ensures the rise of the striking piston and the other one of the two control chambers, with a larger section and also called top chamber or thrust chamber, is alternately supplied with pressurized fluid during the striking stroke of the piston and is connected to a low-pressure return circuit of the apparatus during the rise stroke of the striking piston.

It is known that for a given power of the apparatus, expressed by the product of the value of the striking frequency and of the value of the stroke energy, when the apparatus works in a homogeneous hard ground, it is preferable to favor the stroke energy rather than the striking frequency in order to obtain an optimum productivity.

Conversely, when the apparatus works on a soft ground, it is advantageous to reduce the stroke energy and consequently increase the striking frequency.

The stroke energy corresponds to the kinetic energy imparted on the striking piston, and depends on the striking stroke of the striking piston and on the supply pressure. In order to adjust the striking frequency and the stroke energy suited to the hardness of a given ground, there are many known solutions described for example in the documents EP0214064 and EP0256955 in the name of the Applicant.

The document EP0214064 describes a percussion apparatus which allows achieving an automatic adaptation of the percussion parameters, thanks to the presence, within the cylinder of the apparatus, of a channel fed with fluid according to the position of the striking piston after the impact and the possible bouncing of the latter on the tool.

The document EP0256955 describes a percussion apparatus which allows achieving the same result, according to the pressure variations in the top chamber or the bottom chamber, subsequent to the effect of bouncing of the striking piston on the tool, thanks to the presence of a hydraulic element sensitive to these variations.

In both of these documents, the system that detects the hardness of the ground acts on a slide which switches two or more control channels of a distributor acting on the striking stroke of the striking piston. Thus, the striking frequencies and impact energies automatically depend on the hardness of the materials to be demolished. However, depending on the type of materials, the use conditions, or the supply rate of the apparatus, it may be interesting, for the user, to keep control of the range of automatic variation of these parameters. No system has been provided to adapt this range of variation of parameters (striking frequency, impact energies), and the user is compelled to work with the range of variation that is intrinsic to the percussion apparatus.

### BRIEF SUMMARY

The object of the invention is to provide a method and an apparatus for the implementation thereof, enabling a manual adjustment of the range of automatic variation of the percussion parameters of a percussion apparatus such as a rock breaker, the percussion parameters being for example the impact energy and the striking frequency of the striking piston.

To this end, the present invention concerns a setting method for setting a striking stroke of a striking piston of a percussion apparatus, the setting method comprising the following steps of:
providing a percussion apparatus comprising a striking piston displaceable in a reciprocating manner inside a body of the percussion apparatus and configured to hit a tool at each operating cycle of the percussion apparatus, and a piloting device configured to make the striking stroke of the striking piston vary automatically according to the hardness of the ground encountered by the tool, the piloting device comprising a piloting cylinder, a piloting slide mounted movable in translation within the piloting cylinder according to a direction of displacement and configured to occupy a plurality of piloting positions shifted from one another according to the direction of displacement, and a main piloting chamber delimited by the piloting slide and the piloting cylinder,
setting a range of variation of the striking stroke of the striking piston, the setting step comprising the following steps:
setting of an angular position of the piloting slide with respect to the piloting cylinder,
hydraulic limitation of the translational displacement stroke of the piloting slide according to the direction of displacement by setting the main piloting chamber in communication with a low-pressure return circuit when the piloting slide reaches a communication position which depends on the set angular position of the piloting slide.

According to one implementation of the setting method, the piloting device belonging to the percussion apparatus provided at the provision step includes a connecting channel permanently connected to the low-pressure return circuit and opening into the piloting cylinder, and wherein the percussion apparatus provided at the provision step further includes at least one fluidic communication passage formed on the piloting slide, the limitation step consisting in setting the main piloting chamber in communication with the low-pressure return circuit via the at least one fluidic communication passage when the piloting slide reaches a communication position which depends on the set angular position of the piloting slide.

According to one implementation of the setting method, the piloting device belonging to the percussion apparatus provided at the provision step further includes a plurality of piloting channels each opening into the piloting cylinder and being adapted to be set in communication with a high-pressure fluid supply circuit over at least one portion of the reciprocating movement of the striking piston, and a control channel opening into the piloting cylinder and configured to control the reciprocating movement of the striking piston, the piloting slide being configured to fluidly connect the control channel with at least one of the piloting channels in at least some of the piloting positions that could be occupied by the piloting slide.

The present invention further concerns a percussion apparatus, including:
a body delimiting a piston cylinder,
a striking piston mounted displaceable in a reciprocating manner inside the piston cylinder, and configured to hit a tool during each operating cycle of the percussion apparatus,
a piloting device configured to make a striking stroke of the striking piston vary according to the hardness of the ground encountered by the tool, the piloting device comprising:
a piloting cylinder,
a piloting slide mounted movable in translation within the piloting cylinder according to a direction of displacement and configured to occupy a plurality of piloting positions shifted from one another according to the direction of displacement,
a main piloting chamber delimited by the piloting slide and the piloting cylinder,

characterized in that the piloting slide is mounted movable in rotation within the piloting cylinder and is configured to occupy a plurality of different angular positions angularly shifted from one another, in that the piloting device comprises a connecting channel permanently connected to a low-pressure return circuit and opening into the piloting cylinder, and in that the percussion apparatus further comprises a setting device configured to set a range of variation of the striking stroke of the striking piston, the setting device comprising:
a setting member configured to set the angular position of the piloting slide in the piloting cylinder, and
at least one fluidic communication passage formed on the piloting slide and configured to hydraulically limit the translational displacement stroke of the piloting slide according to the direction of displacement according to the angular position occupied by the piloting slide, the piloting slide being configured to occupy a plurality of communication positions shifted from one another according to the direction of displacement and each associated to a respective angular position of the piloting slide, the at least one fluidic communication passage being configured to fluidly connect the main piloting chamber with the connecting channel when the piloting slide is located in the communication position associated to the angular position occupied by the piloting slide.

Thus, through a simple setting of the angular position of the piloting slide using the setting member, an operator can select the range of variation of the striking stroke of the striking piston, and therefore manually adjust the striking frequency and the impact energy of the striking piston. Thus, the operator can optimize the operation of the percussion apparatus by letting the automatic piloting of the striking stroke of the striking piston operate, but while limiting or increasing the range of variation of the striking stroke to a pre-established value.

The percussion apparatus may further have one or more of the following features, considered separately or in combination.

According to an embodiment of the invention, the piloting slide includes a first end face and a second end face opposite to the first end face.

According to an embodiment of the invention, the first end face of the piloting slide is located opposite a bottom wall of the piloting cylinder and partially delimits the main piloting chamber.

According to an embodiment of the invention, the at least one fluidic communication passage is configured to fluidly connect the main piloting chamber with the connecting channel when the first end face of the piloting slide is located at a predetermined displacement distance from the bottom wall of the piloting cylinder, the value of the predetermined displacement distance varying according to the angular position occupied by the piloting slide.

According to an embodiment of the invention, the setting member includes a setting portion intended to be driven in rotation by a user, and a drive portion secured in rotation with the piloting slide and configured to drive the piloting slide in rotation within the piloting cylinder when the setting portion is driven in rotation by a user, the drive portion being configured to enable a translational displacement of the piloting slide relative to the setting member.

According to an embodiment of the invention, the drive portion is configured to drive the piloting slide in rotation about a longitudinal axis of the piloting slide.

According to an embodiment of the invention, the setting portion is intended to be driven in rotation by a user about an axis of rotation substantially coincident with the longitudinal axis of the piloting slide.

According to an embodiment of the invention, the piloting slide includes an axial mounting bore opening into an end face of the piloting slide, the drive portion being received at least partially within the axial mounting bore.

According to an embodiment of the invention, the axial mounting bore opens into the second end face of the piloting slide.

According to an embodiment of the invention, the axial mounting bore has a non-circular cross-section and the drive portion has a cross-section matching with that of the axial mounting bore.

According to an embodiment of the invention, the drive portion may for example have a flattened portion.

According to an embodiment of the invention, the setting portion is accessible from outside the percussion apparatus.

According to an embodiment of the invention, the setting device includes setting marks provided on a readable area fixed with respect to the body or on the setting member, each setting mark corresponding to a respective value of the range of variation of the striking stroke of the striking piston, and a reading mark associated to the setting marks and provided on the setting member or on the reading area.

According to an embodiment of the invention, the setting marks are distributed around the setting portion of the setting member.

According to an embodiment of the invention, the reading area is provided on the body or on a part affixed on the body, such as a retaining element configured to retain the setting member on the body. For example, the retaining element may comprise an outer tapping configured to cooperate with an inner thread provided on the body, and an access opening configured to enable access to the setting portion.

According to an embodiment of the invention, the piloting device comprises a fluidic communication channel opening respectively into the piston cylinder and into the main piloting chamber, the fluidic communication channel being configured to be set in communication with the low-pressure return circuit, via a peripheral groove provided on the striking piston and a return channel permanently connected to the low-pressure return circuit and opening into the piston cylinder, when the striking piston is in and/or proximate to theoretical striking position.

According to an embodiment of the invention, the piloting device further comprises a flow-rate regulation member configured to ensure, at each operating cycle of the percussion apparatus, an intake of a predetermined amount of fluid into the fluidic communication channel.

According to an embodiment of the invention, the flow-rate regulation member is actuated synchronously with the striking piston.

According to an embodiment of the invention, the flow-rate regulation member is formed by a positive-displacement pump.

According to an embodiment of the invention, the fluidic communication channel is configured to divert, at each operating cycle of the percussion apparatus, a fluid amount coming from the flow-rate regulation member towards the low-pressure return circuit, said fluid amount depending on the stay-time of the striking piston in and/or proximate to its theoretical striking position and therefore on the hardness of the ground encountered by the tool.

According to an embodiment of the invention, the piloting slide includes an inner bore opening into the main piloting chamber, and the setting device includes a plurality of fluidic communication passages formed on the piloting slide and each comprising a first end opening into the inner bore and a second end opening into an outer surface of the piloting slide, the second ends of the fluidic communication passages being shifted from one another according to the direction of displacement and being further angularly shifted from one another.

According to an embodiment of the invention, each fluidic communication passage is associated to a respective communication position of the piloting slide and is configured to fluidly connect the main piloting chamber with the connecting channel when the piloting slide is located in the communication position associated to said fluidic communication passage and occupies the angular position associated to said communication position.

According to an embodiment of the invention, each communication passage extends radially with respect to the direction of displacement of the piloting slide.

According to an embodiment of the invention, the inner bore extends parallel to the direction of displacement of the piloting slide.

According to an embodiment of the invention, the inner bore opens into the first end face of the piloting slide.

According to an embodiment of the invention, the at least one fluidic communication passage is formed on an outer surface, preferably cylindrical, of the piloting slide and extends helically around an axis of extension of the piloting slide. Advantageously, the setting device includes one single fluidic communication passage formed on the outer surface of the piloting slide, the fluidic communication passage extending helically around the axis of extension of the piloting slide. Advantageously, the fluidic communication passage is formed by a helical groove formed on the outer surface of the piloting slide and extending over at least one portion of the outer circumference of the piloting slide.

According to an embodiment of the invention, the piloting device further includes:
a plurality of piloting channels each opening into the piloting cylinder, each piloting channel also opening into the piston cylinder and being adapted to be set in communication with a high-pressure fluid supply circuit over at least one portion of the reciprocating movement of the striking piston, and
a control channel opening into the piloting cylinder and configured to control the reciprocating movement of the striking piston, the piloting slide being configured to fluidly connect the control channel with at least one of the piloting channels in at least some of the piloting positions that could be occupied by the piloting slide.

According to an embodiment of the invention, the piloting channels are configured to piloting different striking stroke lengths.

According to an embodiment of the invention, each of the piloting channels includes a first end opening into the piston cylinder and a second end opening into the piloting cylinder, the first ends of the piloting channels being shifted according to the direction of extension of the striking piston, and the second ends of the piloting channels being shifted according to the direction of displacement of the piloting slide.

According to an embodiment of the invention, the piloting slide comprises a peripheral piloting groove, the peripheral piloting groove and the piloting cylinder delimiting an annular connecting chamber into which the control channel opens, the annular connecting chamber being configured to fluidly connect the control channel with at least one of the piloting channels in at least some of the piloting positions that could be occupied by the piloting slide.

According to an embodiment of the invention, the percussion apparatus further includes a control distributor configured to control a reciprocating movement of the striking piston inside the piston cylinder alternately according to a striking stroke and a return stroke, the control channel being connected to the control distributor.

According to an embodiment of the invention, the plurality of piloting positions includes a first piloting position corresponding to a short stroke of the striking piston, a second piloting position corresponding to a long stroke of the striking piston and a plurality of intermediate piloting positions located between the first and second piloting positions.

According to an embodiment of the invention, the piloting device includes a biasing means configured to bias the piloting slide towards the first piloting position.

According to an embodiment of the invention, the biasing means includes a biasing chamber which is delimited by the piloting slide and the piloting cylinder and which is opposite to the main piloting chamber, and a supply channel permanently connected to a high-pressure fluid supply circuit and opening into the biasing chamber.

According to an embodiment of the invention, the biasing chamber has a cross-section smaller than the cross-section of the main piloting chamber.

According to an embodiment of the invention, the piloting device includes a secondary piloting chamber delimited by the piloting slide and the piloting cylinder, the secondary piloting chamber being permanently connected to the low-pressure return circuit.

According to an embodiment of the invention, the second end face of the piloting slide is located within the secondary piloting chamber.

According to an embodiment of the invention, the striking piston and the piston cylinder delimits a first control chamber permanently connected to the high-pressure fluid supply circuit and a second control chamber, the control distributor being configured to alternately set the second control chamber in connection with the high-pressure fluid supply circuit and the low-pressure return circuit.

According to an embodiment of the invention, each piloting channel is configured to be set in communication with the first control chamber over at least one portion of the reciprocating movement of the striking piston, and for example over at least one portion of the return stroke of the striking piston.

According to an embodiment of the invention, the control channel is connected to a control chamber of the control distributor.

According to an embodiment of the invention, the percussion apparatus is a hydraulic rock breaker.

According to an embodiment of the invention, the piloting cylinder includes a bottom wall located opposite the first end face of the piloting slide.

According to an embodiment of the invention, the piloting cylinder includes an inlet opening configured to enable the introduction of at least one portion of the setting member into the piloting cylinder. Advantageously, the setting member seals the inlet opening.

According to an embodiment of the invention, the fluidic communication channel opens into the bottom wall of the piloting cylinder.

According to an embodiment of the invention, the different piloting positions of the piloting slide corresponding respectively to different striking strokes of the striking piston.

### BRIEF DESCRIPTION OF THE DRAWINGS

Anyway, the invention will be better understood using the following description with reference to the appended schematic drawings representing, as non-limiting examples, several embodiments of this percussion apparatus.

FIG. 1 is a schematic longitudinal sectional view of a percussion apparatus according to a first embodiment of the invention.

FIGS. 2 to 5 are longitudinal sectional views of a piloting device of the percussion apparatus of FIG. 1 in different piloting positions.

FIG. 6 is a cross-sectional view according to the line VI-VI of FIG. 2.

FIG. 7 is a partial view of the percussion apparatus of FIG. 1 showing a first setting of an angular position of a piloting slide of the piloting device, this first setting corresponding to the angular position of the piloting slide shown in FIGS. 2 to 5.

FIG. 8 is a longitudinal sectional view of the piloting device of FIGS. 2 to 5 showing the latter in a second angular position different from that occupied in FIGS. 2 to 5.

FIG. 9 is a partial view of the percussion apparatus of FIG. 1 showing a second setting of an angular position of the piloting slide of the piloting device, this second setting corresponding to the angular position of the piloting slide shown in FIG. 8.

FIG. 10 is a longitudinal sectional view of the piloting device of FIGS. 2 to 5 showing the latter in a third angular position different from that occupied in FIGS. 2 to 5.

FIG. 11 is a partial view of the percussion apparatus of FIG. 1 showing a third setting of an angular position of the piloting slide of the piloting device, this third setting corresponding to the angular position of the piloting slide shown in FIG. 10.

FIG. 12 is a longitudinal sectional view of the piloting device of FIGS. 2 to 5 showing the latter in a fourth angular position different from that occupied in FIGS. 2 to 5.

FIG. 13 is a partial view of the percussion apparatus of FIG. 1 showing a fourth setting of an angular position of the piloting slide of the piloting device, this fourth setting corresponding to the angular position of the piloting slide shown in FIG. 12.

FIG. 14 is a longitudinal sectional view of a piloting device of a percussion apparatus according to a second embodiment of the invention.

### DETAILED DESCRIPTION

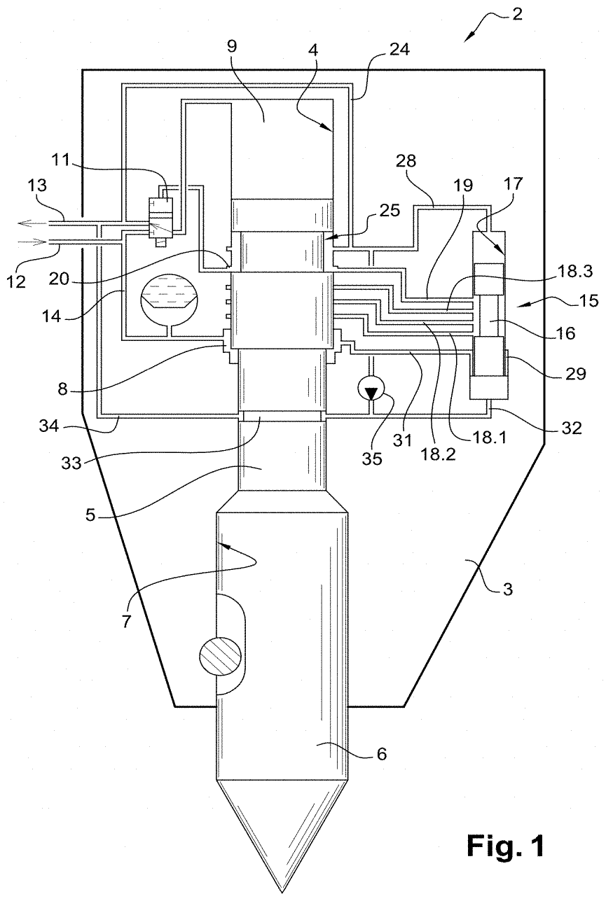

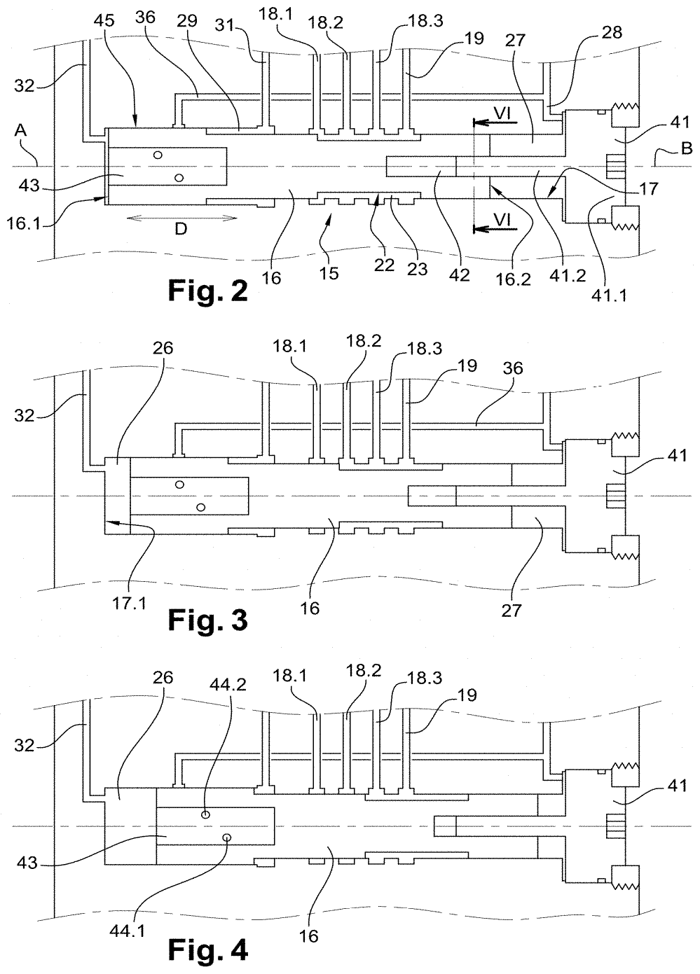

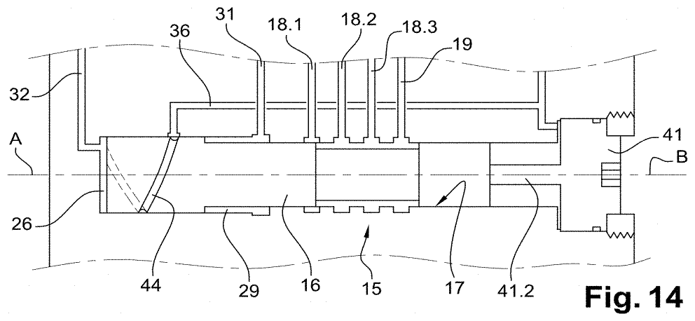

The percussion apparatus 2 represented in FIGS. 1 to 13 comprises a body 3 delimiting a piston cylinder 4, and a stepped striking piston 5 mounted so as to slide in a reciprocating manner inside the piston cylinder 4. During each operating cycle, the striking piston 5 is intended to hit the upper end of a tool 6 slidably mounted within a bore 7 formed in the body 3 coaxially with the piston cylinder 4.

The striking piston 5 and the piston cylinder 4 delimit a first annular control chamber 8, called bottom chamber, and a second control chamber 9, called top or thrust chamber, with a larger section disposed above the striking piston 5.

The percussion apparatus 2 further comprises a control distributor 11 arranged so as to control a reciprocating movement of the striking piston 5 inside the piston cylinder 4 in a reciprocating manner along a striking stroke and a return stroke. The control distributor 11 is configured to alternately set the second control chamber 9 in connection with a high-pressure fluid supply circuit 12 during the striking stroke of the striking piston 5, and with a low-pressure return circuit 13 during the return stroke of the striking piston 5.

More particularly, the control distributor 11 is mounted movable within a bore formed in the body 3 between a first position (cf. FIG. 1) in which the control distributor 11 is configured to set the second control chamber 9 in connection with the low-pressure return circuit 13 and a second position in which the control distributor 11 is configured to set the second control chamber 9 in connection with the high-pressure fluid supply circuit 12.

The first control chamber 8 is permanently supplied with high-pressure fluid through a channel 14, so that each position of the control distributor 11 causes the striking stroke of the striking piston 5, then the return stroke of the striking piston 5. Advantageously, the channel 14 may be connected to an accumulator.

The percussion apparatus 2 also comprises a piloting device 15 configured to make the striking stroke of the striking piston 5 vary between a short striking stroke and a long striking stroke and vice versa, according to the hardness of the ground encountered by the tool 6.

The piloting device 15 comprises a piloting slide 16 mounted within a piloting cylinder 17 formed in the body 3. The piloting slide 16 includes a first end face 16.1 located opposite a bottom wall 17.1 of the piloting cylinder 17 and a second end face 16.2 opposite to the first end face 16.1. Advantageously, the piloting cylinder 17 is stepped.

The piloting slide 16 is slidably mounted within the piloting cylinder 17 according to a direction of displacement D and is configured to occupy a plurality of piloting positions shifted from one another according to the direction of displacement D. In particular, the plurality of piloting positions includes a first piloting position corresponding to a short stroke of the striking piston 5, a second piloting position corresponding to a long stroke of the striking piston 5, and a plurality of intermediate piloting positions located between the first and second piloting positions and corresponding to striking stroke lengths located between the short stroke and the long stroke.

The piloting device 15 further comprises a plurality of piloting channels 18.1, 18.2, 18.3 configured to piloting different striking stroke lengths. Each of the piloting channels 18.1, 18.2, 18.3 includes a first end opening into the piston cylinder 4, and a second end opening into the piloting cylinder 17. The first ends of the piloting channels 18.1, 18.2, 18.3 are shifted according to the direction of extension of the striking piston 5, and the second ends of the piloting channels 18.1, 18.2, 18.3 are shifted according to the direction of displacement D of the piloting slide 16. As shown in FIG. 1, the piloting device 15 may, for example, comprise three piloting channels. However, the piloting device 15 may comprise less than three or more than three piloting channels.

Each piloting channel 18.1, 18.2, 18.3 is adapted to be set in communication with the first control chamber 8, and therefore with the high-pressure fluid supply circuit 12, over at least one portion of the return stroke of the striking piston 5.

The piloting device 15 also comprises a control channel 19 fluidly connected to the control distributor 11 and configured to piloting the operation of the control distributor 11. Advantageously, the control channel 19 opens, on the one hand, into the piloting cylinder 17 and, on the other hand, into the piston cylinder 4 and more particularly into an annular groove 20 formed in the piston cylinder 4.

The piloting slide 16 is also mounted movable in rotation within the piloting cylinder 17 about an axis of rotation A substantially coincident with the longitudinal axis of the piloting slide 16.

According to the embodiment represented in the figures, the piloting slide 16 comprises a peripheral piloting groove 22. The peripheral piloting groove 22 and the piloting cylinder 17 delimit an annular connecting chamber 23 into which the control channel 19 opens. More particularly, the connecting chamber 23 is configured to fluidly connect the control channel 19 with at least one of the piloting channels 18.1, 18.2, 18.3 in some of the piloting positions that could be occupied by the piloting slide 16. Thus, the control channel 19 is adapted to be set in communication with the high-pressure fluid supply circuit 12 via at least one of the piloting channels 18.1, 18.2, 18.3, over at least one portion of the return stroke of the striking piston 5.

The control channel 19 is also configured to be set in communication with the low-pressure return circuit 13 when the striking piston 5 is in and/or proximate to a theoretical striking position (cf. FIG. 1). According to the embodiment represented in FIGS. 1 to 13, the percussion apparatus 2 comprises a channel 24 permanently connected to the low-pressure return circuit 13 and opening into the piston cylinder 4, and the striking piston 5 includes a peripheral groove 25 configured to fluidly connect the channel 24 and the control channel 19 when the striking piston 5 is in and/or proximate to a theoretical striking position.

More particularly, the percussion apparatus 2 is configured such that the control distributor 11 is displaced towards its first position when the control channel 19 is connected to the low-pressure return circuit 13 via the channel 24, and towards its second position when the control channel 19 is connected to the high-pressure fluid supply circuit 12.

The piloting slide 16 and the piloting cylinder 17 delimit a main piloting chamber 26 within which the first end face 16.1 of the piloting slide 16 is located, and a secondary piloting chamber 27 within which the second end face 16.2 of the piloting slide 16 is located. The secondary piloting chamber 27 is opposite to the main piloting chamber 26 and is permanently connected to the low-pressure return circuit 13 through a channel 28.

The piloting slide 16 and the piloting cylinder 17 further delimit a biasing chamber 29 which is also opposite to the main piloting chamber 26, and which is permanently connected to the high-pressure fluid supply circuit 12 via a supply channel 31 opening into the biasing chamber 29. Advantageously, the biasing chamber 29 has a cross-section smaller than the cross-section of the main piloting chamber 26, and is configured to bias the piloting slide 16 towards the first piloting position.

The piloting device 15 also comprises a fluidic communication channel 32 opening respectively into the piston cylinder 4 and into the main piloting chamber 26. The fluidic communication channel 32 is configured to be set in communication with the low-pressure return circuit 13, via a peripheral groove 33 provided on the striking piston 5 and a return channel 34 permanently connected to the low-pressure return circuit 13 and opening into the piston cylinder 4, when the striking piston 5 is in and/or proximate to a theoretical striking position, and in particular when the striking piston 5 is bearing on the tool 6 (cf. FIG. 1). According to the embodiment represented in FIGS. 1 to 13, the end of the fluidic communication channel 32 opening into the piston cylinder 4 is configured to be sealed by an outer wall of the striking piston 5 when the latter is away from its theoretical striking position.

The piloting device 15 further comprises a flow-rate regulation member 35, such as a positive-displacement pump, fluidly connected to the fluidic communication channel 32 and configured to ensure, at each operating cycle of the percussion apparatus 2, an intake of a predetermined amount of fluid into the fluidic communication channel 32. Advantageously, the flow-rate regulation member 35 is actuated synchronously with the striking piston 5.

Thus, more particularly, the fluidic communication channel 32 is configured to divert, at each operating cycle of the percussion apparatus 2, a fluid amount coming from the flow-rate regulation member 35 towards the low-pressure return circuit 13, said fluid amount depending on the stay-time of the striking piston 5 in and/or proximate to its theoretical striking position and therefore on the hardness of the ground encountered by the tool.

If the ground encountered by the tool 6 becomes harder, the stay-time of the striking piston 5 in and/or proximate to its theoretical striking position, as well as the duration of communication of the flow-rate regulation member 35 with the low-pressure return circuit 13 via the fluidic communication channel 32 and the peripheral groove 33, decrease. Therefore, the fluid amount introduced into the main setting chamber 26 increases, which causes a displacement of the piloting slide 16 in a direction increasing the volume of the main piloting chamber 26. Such a displacement of the piloting slide 16 progressively induces a fluidic insulation of the piloting channel 18.1 and of the control channel 19, then a fluidic insulation of the piloting channels 18.1, 18.2 and of the control channel 19 and finally a fluidic insulation of the control channel 19 and of the piloting channels 18.1, 18.2, 18.3. Consequently, such a displacement of the piloting slide 16 translates into an action on the control distributor 11 so that the latter increases the striking stroke of the striking piston 5 up to the long stroke when the control channel 19 is fluidly insulated from the piloting channels 18.1, 18.2, 18.3.

Conversely, if the ground encountered by the tool 6 becomes softer, the stay-time of the striking piston 5 in and/or proximate to its theoretical striking position, as well as the duration of communication of the flow-rate regulation member 35 with the low-pressure return circuit 13 via the fluidic communication channel 32 and the peripheral groove 33, increase. Therefore, the fluid amount introduced into the main setting chamber 26 decreases, which causes a displacement of the piloting slide 16 in a direction reducing the volume of the main piloting chamber 26 by the action of the supply pressure in the biasing chamber 29. A displacement of the piloting slide 16 translates into an action on the control distributor 11 which reduces the striking stroke of the striking piston 5 down to the short stroke when the control channel 19 is fluidly connected to the piloting channel 18.1.

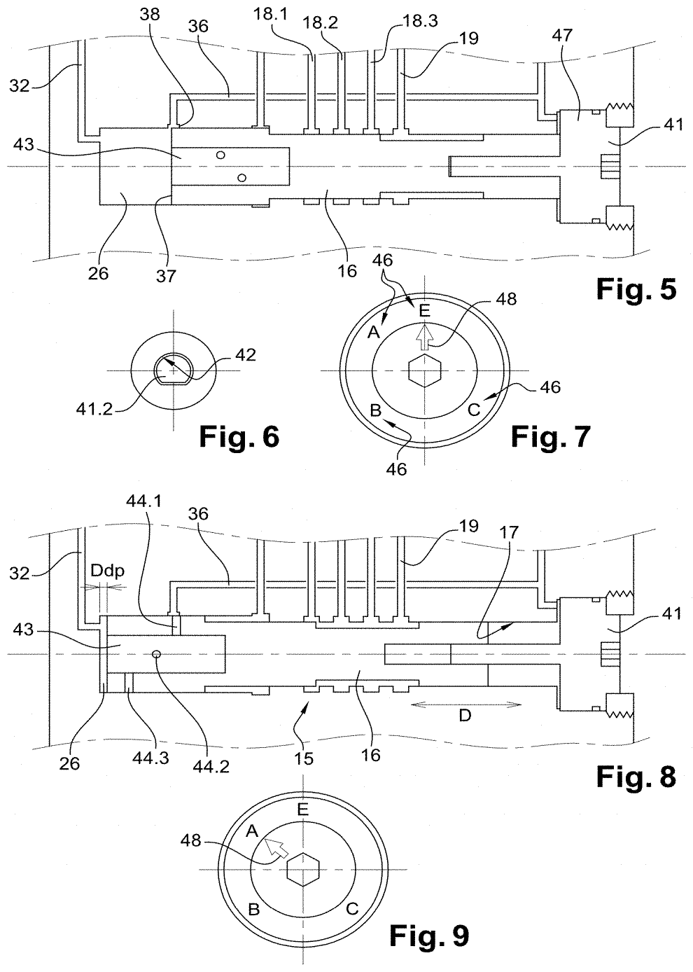

The piloting device 15 further comprises a connecting channel 36 permanently connected to the low-pressure return circuit 13 and opening into the piloting cylinder 17. In particular, the connecting channel 36 is configured to connect the main piloting chamber 26 with the low-pressure return circuit 13 when the piloting slide 16 reaches the second piloting position (which corresponds to a control of the long stroke of the striking piston 5) in which the end edge 37 of the piloting slide 16 uncovers the end 38 of the connecting channel 36 opening into the piloting cylinder 17 (cf. FIG. 5).

The percussion apparatus 2 further comprises a setting device configured to set a range of variation of the striking stroke of the striking piston 5.

The setting device comprises a setting member 41 configured to set an angular position of the piloting slide 16 in the piloting cylinder 17. According to the embodiment represented in FIGS. 1 to 13, the setting member 41 includes a setting portion 41.1 intended to be driven in rotation by a user about an axis of rotation B substantially coincident with the longitudinal axis of the piloting slide 16. Advantageously, the setting portion 41.1 is accessible from outside the percussion apparatus 2.

The setting member 41 also includes a drive portion 41.2 secured in rotation with the piloting slide 16 and configured to drive the piloting slide 16 in rotation within the piloting cylinder 17 when the setting portion 41.1 is driven in rotation by a user. According to the embodiment represented in FIGS. 1 to 13, the piloting slide 16 includes an axial mounting bore 42 opening into the second end face 16.2 of the piloting slide 16, and the drive portion 41.2 is received at least partially within the axial mounting bore 42.

More particularly, the drive portion 41.2 is configured to enable a translational displacement of the piloting slide 16 relative to the setting member 41. For this purpose, the axial mounting bore 42 advantageously has a non-circular cross-section, and the drive portion 41.2 has a cross-section matching with that of the axial mounting bore 42. For example, the drive portion 41.2 may have a flattened portion formed on its outer surface (cf. FIG. 6).

According to the embodiment represented in FIGS. 1 to 13, the piloting slide 16 also includes an inner bore 43 opening into the first end face 16.1 of the piloting slide 16, and therefore into the main piloting chamber 26, and the setting device further comprises a plurality of fluidic communication passages 44.1, 44.2, 44.3 formed on the piloting slide 16. Each of the fluidic communication passages 44.1, 44.2, 44.3 comprises a first end opening into the inner bore 43, and a second end opening into a cylindrical outer surface 45 of the piloting slide 16. The second ends of the fluidic communication passages 44.1, 44.2, 44.3 are, on the one hand, shifted from one another according to the direction of displacement D and, on the other hand, angularly shifted from one another. For example, each of the fluidic communication passages 44.1, 44.2, 44.3 may extend radially with respect to the direction of displacement D of the piloting slide 16, and the inner bore 43 may for example open into the first end face 16.1 of the piloting slide 16 and extend parallel to the direction of displacement D of the piloting slide 16.

As shown in FIGS. 8, 10, 12, the piloting slide 16 is configured to occupy a plurality of communication position shifted from one another according to the direction of displacement D and each associated to a respective angular position of the piloting slide 16, and each of the fluidic communication passages 44.1, 44.2, 44.3 is associated to a respective communication position of the piloting slide and is configured to fluidly connect the main piloting chamber 26 with the connecting channel 36 when the piloting slide 16 is located in the communication position associated to said fluidic communication passage and occupies the angular position associated to said communication position. In other words, each of the fluidic communication passages 44.1, 44.2, 44.3 is configured to fluidly connect the main piloting chamber 26 with the connecting channel 36 when the first end face 16.1 of the piloting slide 16 is located at a predetermined displacement distance Ddp from the bottom wall 17.1 of the piloting cylinder 17, the value of the predetermined displacement distance Ddp varying according to the angular position occupied by the piloting slide 16.

In addition, the setting device includes setting marks 46, for example four setting marks respectively identified by the references E, A, B, C, provided directly on the body 3 or on a part affixed and fastened on the body 3, such as a retaining ring 47 configured to retain the setting member 41 on the body 3. Each setting mark 46 corresponds to a respective value of the range of variation of the striking stroke of the striking piston 5. Advantageously, the setting marks 46 are distributed around the setting portion 41.1 of the setting member 41.

The setting device also includes a reading mark 48, such as an arrow, provided on the setting member 41 and configured to be located opposite one of the setting marks 46 according to the angular position occupied by the piloting slide 16 and set by the setting member 41, so as to allow identifying to which value of the range of variation corresponds the set angular position of the piloting slide 16.

According to the embodiment represented in FIGS. 1 to 13, the setting mark 46 identified by the reference E corresponds to an angular position of the piloting slide 16 in which none of the fluidic communication passages 44.1, 44.2, 44.3 could be fluidly connected to the connecting channel 36. Thus, a setting of the setting member 41 such that the reading mark 48 is located opposite the setting mark 46 identified by the reference E enables a translational displacement of the piloting slide 16 up to the second piloting position represented in FIG. 5. Hence, the setting mark 46 identified by the reference E corresponds to a maximum value of the range of variation of the striking stroke of the striking piston 5.

According to the embodiment represented in FIGS. 1 to 13, the setting mark 46 identified by the reference A corresponds to an angular position of the piloting slide 16 in which the fluidic communication passage 44.1 is configured to fluidly connect the main piloting chamber 26 to the connecting channel 36, and therefore stop the displacement of the piloting slide 16 according to the direction of displacement D, when the piloting slide 16 reaches a communication position represented in FIG. 8 and in which the piloting channel 18.1 is fluidly connected to the control channel 19. Hence, the setting mark 46 identified by the reference A corresponds to a minimum value of the range of variation of the striking stroke of the striking piston 5, since in this angular position of the piloting slide 16, the striking piston 5 can cover only the short stroke.

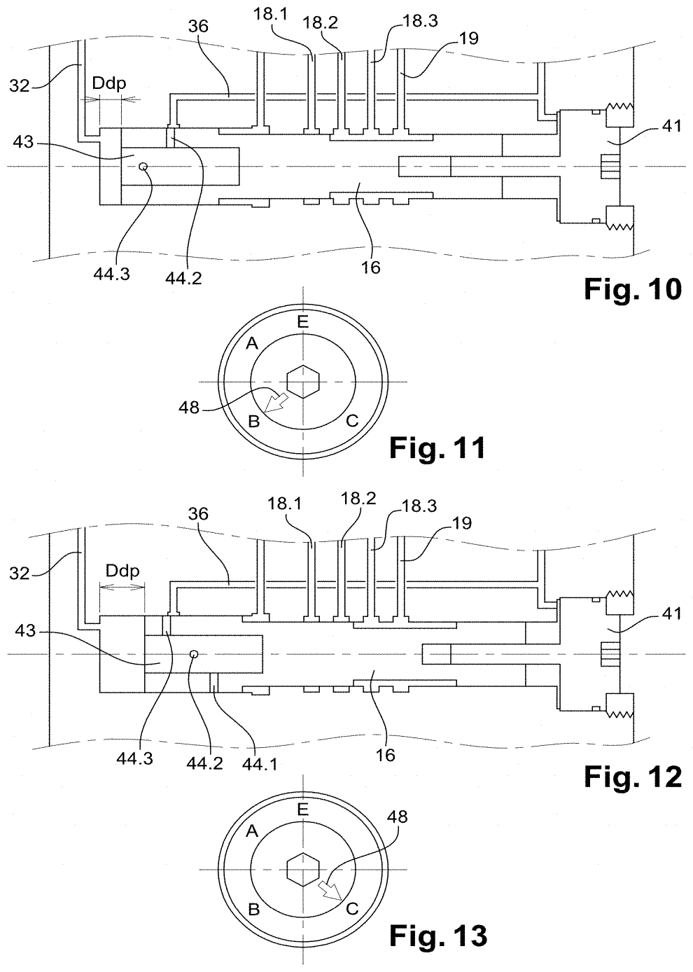

According to the embodiment represented in FIGS. 1 to 13, the setting mark 46 identified by the reference B corresponds to an angular position of the piloting slide 16 in which the fluidic communication passage 44.2 is configured to fluidly connect the main piloting chamber 26 to the connecting channel 36, and therefore stop the displacement of the piloting slide 16 according to the direction of displacement D, when the piloting slide 16 reaches a communication position represented in FIG. 10 and in which the piloting channel 18.2 is fluidly connected to the control channel 19. Hence, the setting mark 46 identified by the reference B corresponds to a first intermediate value of the range of variation of the striking stroke of the striking piston 5, since in this angular position of the piloting slide 16, the striking piston 5 can cover a striking stroke longer than the short stroke, and in particular ranging from the short stroke up to the striking stroke piloted by the piloting channel 18.2.

According to the embodiment represented in FIGS. 1 to 13, the setting mark 46 identified by the reference C corresponds to an angular position of the piloting slide 16 in which the fluidic communication passage 44.3 is configured to fluidly connect the main piloting chamber 26 to the connecting channel 36, and therefore stop the displacement of the piloting slide 16 according to the direction of displacement D, when the piloting slide 16 reaches a communication position represented in FIG. 12 and in which the piloting channel 18.3 is fluidly connected to the control channel 19. Hence, the setting mark identified by the reference C corresponds to a second intermediate value of the range of variation of the striking stroke of the striking piston 5 that is higher than the first intermediate value, since in this angular position of the piloting slide 16, the striking piston 5 can cover a striking stroke even longer than the striking stroke defined by the setting mark 46 identified by the reference B, and in particular ranging from the short stroke up to the striking stroke piloted by the piloting channel 18.3.

Thus, through a simple angular setting of the position of the setting member 41, an operator can select the range of variation of the striking stroke of the striking piston 5, and therefore adjust the striking frequency and the impact energy of the striking piston 5. Thus, the operator can optimize the operation of the percussion apparatus 2 by letting the automatic piloting of the striking stroke of the striking piston 5 operate, but while limiting the range of variation of the striking stroke to a pre-established value.

According to another embodiment of the invention which is not represented in the figures, the setting device may comprise more than three setting marks 46 and more than three fluid communication passages, and that in order to allow selecting a larger number of possible values for the range of variation of the striking stroke of the striking piston 5.

FIG. 14 represents a piloting device 15 and a setting device of a percussion apparatus 2 according to a second embodiment of the invention. The setting device of such an embodiment differs from that represented in FIGS. 1 to 13 essentially in that it includes one single fluidic communication passage 44 formed on the cylindrical outer surface of the piloting slide 16 and extending helically. Advantageously, the fluidic communication passage 44 is formed by a helical groove which extends over a portion of the outer circumference of the piloting slide 16.

Such a configuration of the setting device allows obtaining a progressive and continuous setting of the range of variation of the striking stroke of the striking piston 5 according to the angular position of the piloting slide 16 set using the setting member 41. Indeed, the configuration of the fluidic communication passage 44 allows connecting the main piloting chamber 26 with the connecting channel 36 at different displacement levels of the piloting slide 16, according to the angular position of the latter.

It goes without saying that the invention is not limited to the sole embodiments of this percussion apparatus, described hereinabove as examples, but it encompasses, on the contrary, all variants thereof.

1. A setting method for setting a striking stroke of a striking piston of a percussion apparatus, the setting method comprising the following steps:
providing a percussion apparatus comprising a striking piston displaceable in a reciprocating manner inside a body of the percussion apparatus and configured to hit a tool at each operating cycle of the percussion apparatus, and a piloting device configured to make the striking stroke of the striking piston vary automatically according to the hardness of the ground encountered by the tool, the piloting device comprising a piloting cylinder, a piloting slide mounted movable in translation within the piloting cylinder according to a direction of displacement and configured to occupy a plurality of piloting positions shifted from one another according to the direction of displacement, and a main piloting chamber delimited by the piloting slide and the piloting cylinder,
setting a range of variation of the striking stroke of the striking piston, the setting step comprising the following steps:
setting of an angular position of the piloting slide with respect to the piloting cylinder,
hydraulic limitation of the translational displacement stroke of the piloting slide according to the direction of displacement by setting the main piloting chamber in communication with a low-pressure return circuit when the piloting slide reaches a communication position which depends on the set angular position of the piloting slide.

2. The setting method according to claim 1, wherein the piloting device belonging to the percussion apparatus provided at the provision step includes a connecting channel permanently connected to the low-pressure return circuit and opening into the piloting cylinder, and wherein the percussion apparatus provided at the provision step further includes at least one fluidic communication passage formed on the piloting slide, the limitation step consisting in setting the main piloting chamber in communication with the low-pressure return circuit via the at least one fluidic communication passage when the piloting slide reaches a communication position which depends on the set angular position of the piloting slide.

3. The setting method according to claim 1, wherein the piloting device belonging to the percussion apparatus provided at the provision step further includes a plurality of piloting channels each opening into the piloting cylinder and being adapted to be set in communication with a high-pressure fluid supply circuit over at least one portion of the reciprocating movement of the striking piston, and a control channel opening into the piloting cylinder and configured to control the reciprocating movement of the striking piston, the piloting slide being configured to fluidly connect the control channel with at least one of the piloting channels in at least some of the piloting positions that could be occupied by the piloting slide.

4. A percussion apparatus, including:
a body delimiting a piston cylinder,
a striking piston mounted displaceable in a reciprocating manner inside the piston cylinder, and configured to hit a tool during each operating cycle of the percussion apparatus,
a piloting device configured to make a striking stroke of the striking piston vary according to the hardness of the ground encountered by the tool, the piloting device comprising:
a piloting cylinder,
a piloting slide mounted movable in translation within the piloting cylinder according to a direction of displacement and configured to occupy a plurality of piloting positions shifted from one another according to the direction of displacement,
a main piloting chamber delimited by the piloting slide and the piloting cylinder,
wherein the piloting slide is mounted movable in rotation within the piloting cylinder and is configured to occupy a plurality of different angular positions angularly shifted from one another, in that the piloting device comprises a connecting channel permanently connected to a low-pressure return circuit and opening into the piloting cylinder, and in that the percussion apparatus further comprises a setting device configured to set a range of variation of the striking stroke of the striking piston, the setting device comprising:
a setting member configured to set the angular position of the piloting slide in the piloting cylinder, and
at least one fluidic communication passage formed on the piloting slide and configured to hydraulically limit the translational displacement stroke of the piloting slide according to the direction of displacement according to the angular position occupied by the piloting slide, the piloting slide being configured to occupy a plurality of communication positions shifted from one another according to the direction of displacement and each associated to a respective angular position of the piloting slide, the at least one fluidic communication passage being configured to fluidly connect the main piloting chamber with the connecting channel when the piloting slide is located in the communication position associated to the angular position occupied by the piloting slide.

5. The percussion apparatus according to claim 4, wherein the setting member includes a setting portion intended to be driven in rotation by a user, and a drive portion secured in rotation with the piloting slide and configured to drive the piloting slide in rotation within the piloting cylinder when the setting portion is driven in rotation by a user, the drive portion being configured to enable a translational displacement of the piloting slide relative to the setting member.

6. The percussion apparatus according to claim 5, wherein the piloting slide includes an axial mounting bore opening into an end face of the piloting slide, the drive portion being received at least partially within the axial mounting bore.

7. The percussion apparatus according to claim 5, wherein the setting device includes setting marks provided on a readable area fixed with respect to the body or on the setting member, each setting mark corresponding to a respective value of the range of variation of the striking stroke of the striking piston, and a reading mark associated to the setting marks and provided on the setting member or on the reading area.

8. The percussion apparatus according to claim 4, wherein the piloting device comprises a fluidic communication channel opening respectively into the piston cylinder and into the main piloting chamber, the fluidic communication channel being configured to be set in communication with the low-pressure return circuit, via a peripheral groove provided on the striking piston and a return channel permanently connected to the low-pressure return circuit and opening into the piston cylinder, when the striking piston is in and/or proximate to theoretical striking position.

9. The percussion apparatus according to claim 8, wherein the piloting device further comprises a flow-rate regulation member configured to ensure, at each operating cycle of the percussion apparatus, an intake of a predetermined amount of fluid into the fluidic communication channel.

10. The percussion apparatus according to claim 4, wherein the piloting slide includes an inner bore opening into the main piloting chamber, and the setting device includes a plurality of fluidic communication passages formed on the piloting slide and each comprising a first end opening into the inner bore and a second end opening into an outer surface of the piloting slide, the second ends of the fluidic communication passages being shifted from one another according to the direction of displacement and being further angularly shifted from one another.

11. The percussion apparatus according to claim 4, wherein the at least one fluidic communication passage is formed on an outer surface of the piloting slide and extends helically around an axis of extension of the piloting slide.

12. The percussion apparatus according to claim 4, wherein the piloting device further includes:
a plurality of piloting channels each opening into the piloting cylinder, each piloting channel also opening into the piston cylinder and being adapted to be set in communication with a high-pressure fluid supply circuit over at least one portion of the reciprocating movement of the striking piston, and
a control channel opening into the piloting cylinder and configured to control the reciprocating movement of the striking piston, the piloting slide being configured to fluidly connect the control channel with at least one of the piloting channels in at least some of the piloting positions that could be occupied by the piloting slide.

13. The percussion apparatus according to claim 4, wherein the plurality of piloting positions includes a first piloting position corresponding to a short stroke of the striking piston, a second piloting position corresponding to a long stroke of the striking piston and a plurality of intermediate piloting positions located between the first and second piloting positions.

14. The percussion apparatus according to claim 13, wherein the piloting device includes a biasing means configured to bias the piloting slide towards the first piloting position.

15. The percussion apparatus according to claim 14, wherein the biasing means includes a biasing chamber which is delimited by the piloting slide and the piloting cylinder and which is opposite to the main piloting chamber, and a supply channel permanently connected to a high-pressure fluid supply circuit and opening into the biasing chamber.

16. The setting method according to claim 2, wherein the piloting device belonging to the percussion apparatus provided at the provision step further includes a plurality of piloting channels each opening into the piloting cylinder and being adapted to be set in communication with a high-pressure fluid supply circuit over at least one portion of the reciprocating movement of the striking piston, and a control channel opening into the piloting cylinder and configured to control the reciprocating movement of the striking piston, the piloting slide being configured to fluidly connect the control channel with at least one of the piloting channels in at least some of the piloting positions that could be occupied by the piloting slide.

17. The percussion apparatus according to claim 6, wherein the setting device includes setting marks provided on a readable area fixed with respect to the body or on the setting member, each setting mark corresponding to a respective value of the range of variation of the striking stroke of the striking piston, and a reading mark associated to the setting marks and provided on the setting member or on the reading area.

18. The percussion apparatus according to claim 17, wherein the piloting device comprises a fluidic communication channel opening respectively into the piston cylinder and into the main piloting chamber, the fluidic communication channel being configured to be set in communication with the low-pressure return circuit, via a peripheral groove provided on the striking piston and a return channel permanently connected to the low-pressure return circuit and opening into the piston cylinder, when the striking piston is in and/or proximate to theoretical striking position.

19. The percussion apparatus according to claim 18, wherein the piloting device further comprises a flow-rate regulation member configured to ensure, at each operating cycle of the percussion apparatus, an intake of a predetermined amount of fluid into the fluidic communication channel.

20. The percussion apparatus according to claim 19, wherein the piloting slide includes an inner bore opening into the main piloting chamber, and the setting device includes a plurality of fluidic communication passages formed on the piloting slide and each comprising a first end opening into the inner bore and a second end opening into an outer surface of the piloting slide, the second ends of the fluidic communication passages being shifted from one another according to the direction of displacement and being further angularly shifted from one another.
